(19) United States
(12) Patent Application Publication
(10) Pub. No.: US 2008/0043660 A1
(43) Pub. Date: Feb. 21, 2008

(54) METHOD OF TRANSFERRING DATA TO A HANDHELD PERSONAL ELECTRONIC DEVICE

(76) Inventor: MARK WHITE, Marina Del Rey, CA (US)

Correspondence Address: CONNOLLY BOVE LODGE & HUTZ LLP, P.O. BOX 2207, WILMINGTON, DE, 19899, US

(21) Appl. No.: 11/692,022

(22) Filed: Mar. 27, 2007

Related U.S. Application Data
(60) Provisional application No. 60/822,983, filed on Aug. 21, 2006.

(51) Int. Cl. H04Q 7/00

(52) U.S. Cl. 370/313

(57) ABSTRACT

A method for transferring data to a handheld personal electronic device is disclosed. Information is collected from a user of the handheld personal electronic device, and select information from among the collected information is identified as data to be transferred to the handheld personal electronic device. The data is then embedded into a file containing executable code which is adapted to display the data in a predetermined format on the handheld personal electronic device. A message which includes an address to the file stored on a server is sent to the handheld personal electronic device. When the handheld personal electronic device queries the address, the file is transferred from the server to the handheld personal electronic device.

### PRIORITY

Priority is claimed to U.S. Provisional Patent Application No. 60/822,983, filed Aug. 21, 2006, the disclosure of which is incorporated herein by reference.

### BACKGROUND OF THE INVENTION

1. Field of the Invention

The field of the present invention is mobile data services, particularly mobile data services which enable an individual to transfer important personal medical information to a handheld personal electronic device in an easily accessible and readable format.

2. Background

The types of information which can be stored on a handheld personal electronic devices are generally limited by the types of executable programs (applications) pre-installed on such devices. Common types of applications include a contact manager and a calendar. These types of applications generally operate as simple databases and have limited functionality to the extent that they are only capable of dealing with predetermined types of information—they are not capable of storing free form data such as emergency medical information concerning the user of the device. Further, they generally do not provide any ability to make one entry in the database, for example the contact information for the user's personal physician, stand out from among all other entries. Other applications may sometimes be installed on such devices. However, for many devices, the most common genre of such installable applications is games, and games do not allow the user to record and recall information that is not related to the game itself. Unfortunately, the market for more advanced data management applications does not exist for a large segment of handheld personal electronic devices that exist on the market today.

More advanced handheld personal electronic devices might also include a word processor and a spreadsheet application, which may be used to store and aggregate information. For example, a word processor on an advanced device might be used to create a document that includes both emergency medical information concerning the user and contact information for the user's personal physician.

Having the ability to aggregate information, especially emergency medical information is beneficial to all users of handheld personal electronic devices. Unfortunately, with the state of the art as it stands now, only those owners of the more advanced handheld personal electronic devices with a word processor or spreadsheet application installed have this ability. Thus, innovative processes are needed to assist users of the not-so-advanced handheld personal electronic device in aggregating important information in a single location on the mobile device. Importantly, the aggregated information should also be easily accessed and readable by the user or by medical personnel if the user is incapacitated. Preferably, such processes should also make it easy to transfer the information to handheld personal electronic devices and enable to user to include more than basic text with the information.

### SUMMARY OF THE INVENTION

The present invention is directed toward a method of transferring data to a handheld personal electronic device. Information is initially collected from a user of the handheld personal electronic device. From this information, selected portions are identified as the data to be transferred to the handheld personal electronic device. This data is embedded into a file containing executable code, which is adapted to display the data in a predetermined format on the handheld personal electronic device. Next, a message which includes an address to the file stored on a server is sent to the handheld personal electronic device. When the handheld personal electronic device queries the address, the file is transferred from the server to the handheld personal electronic device.

Many different options are available to enhance the transfer of data. As a first option, the user may be provided with the opportunity to mark parts of the collected information as private, and the data is generated from among those portions of the information that are not marked private. As another option, the information may be collected from the user using an electronic interface, such as one that could be presented to the user via the Internet. Additionally, the message including the address may be sent to the handheld personal electronic device as a text message via the Short Message Service (SMS) protocol, or as part of an email message. Preferably, the address is in the form of an Internet protocol link, thus enabling the user to quickly and easily direct the handheld personal electronic device to query the address.

Accordingly, an improved method for transferring data to a handheld personal electronic device is disclosed. Advantages of the improvements will appear from the drawings and the description of the preferred embodiment.

### BRIEF DESCRIPTION OF THE DRAWINGS

In the drawings, wherein like reference numerals refer to similar components:

FIG. 1 is a flowchart illustrating the process for transferring data to a handheld personal electronic device; and

FIG. 2 schematically illustrates a networked system for providing convenient access to personal information.

### DETAILED DESCRIPTION OF THE PREFERRED EMBODIMENTS

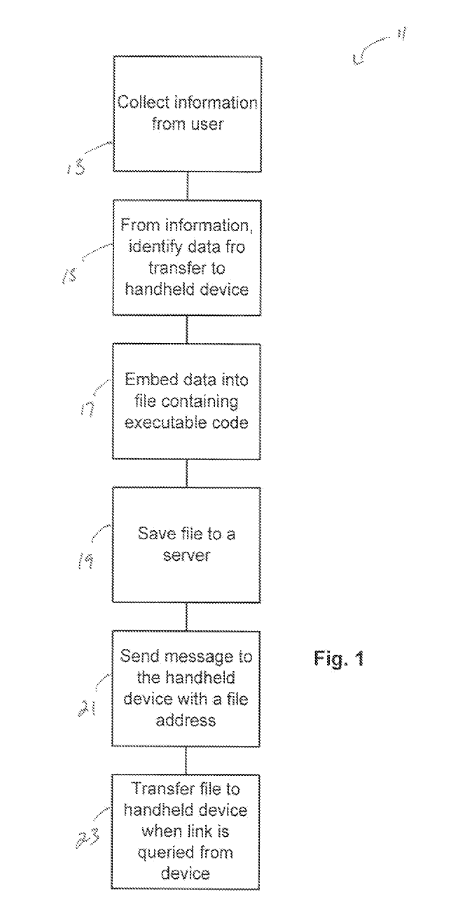

Turning in detail to the drawings, FIG. 1 illustrates a process 11 for transferring data to a handheld personal electronic device. Preferably, the handheld personal electronic device is capable of being wirelessly connected to a network, although in some instances a wired connection, preferably a temporary one, will suffice. As a first step in the process 11, information is collected 13 from the user of the handheld personal electronic device. This information may be of any type the user desires to transfer to the handheld personal electronic device. It may include text-based information, a graphic, a picture, e.g., a photo of the user, audio-based information, or any combination of the foregoing. The type of information that may be transferred will generally be limited by the implementation of the overall process 11 and the hardware elements used for implementing the process, particularly the user's handheld personal electronic device.

The information is preferably collected through an electronic interface, such as a web page form which is hosted on a server and accessed by the user from a remote location over the Internet. The information may also be collected in any number of alternative ways, such as through kiosks placed at collection points, through a personal interview, or by having the user complete a paper-based form and return it to a data processing center. Any one of a variety of collection methods will suffice.

Following collection of the information 13, the information is processed to identify 15 a subset of the information, referred to herein as the data, which is to be transferred to the handheld personal electronic device. Depending upon the type of information provided and the needs of the user, this subset may include all of the information, or it may be a reduced set. For example, part of the information may include the phone number for and the name of the carrier which provides wireless service to the handheld personal electronic device. The phone number and the name of the carrier, however, may not be information which is needed or wanted as part of the data transferred to the handheld personal electronic device. By way of another example, the user may be afforded the opportunity to mark select parts of the information as “private”. Thereafter, those portions of the information marked “private” would not be included as part of the data. However, the entirety of the information provided by the user is preferably retained and stored on an appropriately secured server for later access, either by the user or by persons authorized by the user. As is evident from the foregoing description, the data identification step may be as simple or as complex as needed.

Following identification, the data is embedded 17 into a file containing executable code. The executable code is in a suitable programming language which permits the data to be displayed on the user's handheld personal electronic device without requiring use of a secondary application to process the data on the handheld personal electronic device. Further, the executable code is designed to display the data in a native format, i.e., text is displayed as text (as opposed to text being displayed as part of an image) and an image is displayed as an image in a predetermined format (as opposed to being embedded into a larger image with other data). In the event that a graphic, photo, or image is part of the data the user seeks to transfer, it may be necessary to alter the graphic, photo, or image by reducing the size, reducing color, or converting the graphic, photo, or image from one image compression format to another. Essentially, if the data does not already conform to predetermined format specifications, then the data is converted so that it does conform and can be displayed on the handheld personal electronic device by the executable code.

Further, depending upon the choice of programming language, the file may need to be complied to generate a stand-alone executable file for transfer to the handheld personal electronic device. An example of a suitable programming language is Java™, because many handheld personal electronic devices, even some of the more basic cell phones, have the ability to run Java programs without requiring the user to install additional files or run additional applications.

After embedding 17 the data into the file, the file is saved to a server 19 for subsequent access by the user. The server is connected to a wide area network, preferably the Internet, to facilitate the user's subsequent access. A message, preferably using the common Short Message Service (SMS) implemented by carriers of wireless phone service, is sent 21 to the handheld personal electronic device to alert the user that the file is available for download. Optionally, the message could be sent via email, or any other alternate mode of message transmission, depending upon the design of the overall system and the ability of the user to access email from the handheld personal electronic device. The message includes an address where the file resides on the server and provides the user with direct access to the file simply by directing the handheld personal electronic device to query the address according. Preferably, this address is in the form of a common Internet protocol link, such as Hypertext Protocol (HTTP), File Transfer Protocol (FTP), and the like. Once the user of the handheld personal electronic device is in possession of the address, the user may, at leisure, query the address to transfer 23 the file from the server to the handheld personal electronic device.

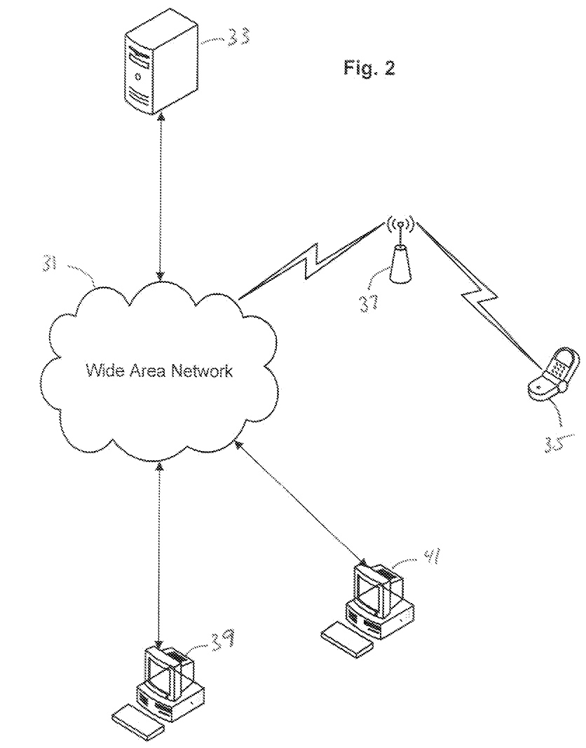

FIG. 2 illustrates a system through which user information may be processed and accessed according to the procedures described above. The physical location of the various elements of this system are unimportant-rather the important aspect of the system is that all of the elements are capable of communication via a network to perform the desired tasks. Such communication may even be intermittent. To achieve this, each of the elements are connected to a Wide Area Network (WAN) 31, preferably the Internet. The server 33, which is connected to the WAN 31, accepts, processes, and stores information provided by the user and stores the executable file into which the user's data is embedded. Optionally separate servers may be used for one or more of these functions.

The user's handheld personal electronic device, which in this instance is a cell phone 35, is connected to the WAN 31 through a wireless carrier 37. When data transferred to the cell phone 35, as part of an executable file, includes medical information about the user, the cell phone may be marked to indicate the presence of the executable file, or more preferably, a button on the cell phone is marked and designated to launch the executable file when pressed. Such indicia and mode of operation can help save the life of the user in the event that the user is incapacitated and medical personnel gain access to the cell phone 35.

Two computing devices 39, 41, which serve as electronic interfaces to access information and data processing systems stored on the server 33, are also connected to the WAN 31. The first computing device 39 is employed by the user to submit to the server information which the user desires to have transferred to the cell phone 37. This first computing device 39 may also be subsequently employed by the user to alter previously submitted information, thereby enabling the user to replace the executable file stored on the cell phone 35 with a new file containing updated data. The second computing device 41 is available to an authorized third party for gaining access to information stored on the server 33. Enabling authorized third parties to access the information may be important in instances where the user's information includes important medical treatment information and the user marked parts of this information as private when submitting it to the server, i.e. the private information is not available by launching the executable file on the cell phone 35. Under such circumstances, authorized medical personnel may still review the private information by accessing the server 33 through the second computing device 41.

Thus, a method for transferring data to a handheld personal electronic device is disclosed. While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A method for transferring data to a handheld personal electronic device, the method comprising:
collecting information from a user of the handheld personal electronic device;
identifying select information from among the collected information as data to be transferred to the handheld personal electronic device;
embedding the data in a file containing executable code, wherein the executable code is adapted to display the data in a predetermined format on the handheld personal electronic device;
sending a message to the handheld personal electronic device, the message including an address to the file stored on a server; and
transferring the file from the server to the handheld personal electronic device when the handheld personal electronic device queries the address.

2. The method of claim 1 further comprising:
allowing the user to mark parts of the collected information as private; and
identifying the select information from among portions of the collected information which are not marked private.

3. The method of claim 1, wherein collecting the information includes collecting the information using an electronic interface.

4. The method of claim 1, wherein the data comprises a phone number for the handheld personal electronic device.

5. The method of claim 1, wherein the data comprises a graphic.

6. The method of claim 1, wherein the file comprises an executable program.

7. The method of claim 1, wherein embedding the data in a file comprises converting the data according to predetermined format specifications.

8. The method of claim 1, wherein sending the message comprises sending the message as an Short Message Service (SMS) text message.

9. The method of claim 1, wherein sending the message comprises sending the message as an email.

10. The method of claim 1, wherein the address is in the form of an Internet protocol link.

11. A method for transferring data to a handheld personal electronic device, the method comprising:
collecting information from a user of the handheld personal electronic device, the information including a phone number for the handheld personal electronic device;
identifying select information from among the collected information as data to be transferred to the handheld personal electronic device;
embedding the data in a file containing executable code to create an executable program, wherein the executable code is adapted to display the data in a predetermined format on the handheld personal electronic device;
sending a message to the handheld personal electronic device, the message including an Internet protocol link to the file stored on a server; and
transferring the file from the server to the handheld personal electronic device when the handheld personal electronic device queries the address.

12. The method of claim 11 further comprising:
allowing the user to mark parts of the collected information as private; and
identifying the select information from among portions of the collected information which are not marked private.

13. The method of claim 11, wherein collecting the information includes collecting the information using an electronic interface.

14. The method of claim 11, wherein the data comprises medical information about the user.

15. The method of claim 11, wherein the data comprises a photo of the user.

16. The method of claim 11, wherein embedding the data in a file comprises converting the data according to predetermined format specifications.

17. The method of claim 11, wherein sending the message comprises sending the message as an Short Message Service (SMS) text message.

18. The method of claim 11, wherein sending the message comprises sending the message as an email.

19. A method for transferring data to a handheld personal electronic device, the method comprising:
collecting information from a user of the handheld personal electronic device using an electronic interface, the information including a phone number for the handheld personal electronic device and medical information about the user;
allowing the user to mark parts of the collected information as private;
identifying select information from among portions of the collected information which are not marked private as data to be transferred to the handheld personal electronic device;
converting the data according to predetermined format specifications;
embedding the converted data in a file containing executable code to create an executable program, wherein the executable code is adapted to display the data in a predetermined format on the handheld personal electronic device;
sending a message to the handheld personal electronic device, the message including an Internet protocol link to the file stored on a server; and
transferring the file from the server to the handheld personal electronic device when the handheld personal electronic device queries the address.

20. The method of claim 19, wherein the data comprises a photo of the user.

21. The method of claim 19, wherein sending the message comprises sending the message as an Short Message Service (SMS) text message.

22. The method of claim 19, wherein sending the message comprises sending the message as an email.
